(19) United States
(12) Patent Application Publication
(10) Pub. No.: US 2025/0162539 A1
(43) Pub. Date: May 22, 2025

(54) OCCUPANT AUTHENTICATION APPARATUS, OCCUPANT AUTHENTICATION METHOD, AND COMPUTER-READABLE MEDIUM

(71) Applicant: NEC Corporation, Minato-ku, Tokyo (JP)

(72) Inventor: Yuta SHIMIZU, Tokyo (JP)

(73) Assignee: NEC Corporation, Minato-ku, Tokyo (JP)

(21) Appl. No.: 18/841,424

(22) PCT Filed: Aug. 2, 2023
(86) PCT No.: PCT/JP2023/028259

§ 371 Date: Aug. 26, 2024

(30) Foreign Application Priority Data
Aug. 31, 2022 (JP) 2022-138697

(51) Int. Cl. B60R 25/25; B60R 25/10; B60R 25/30; B60R 25/32

(52) U.S. Cl. CPC B60R 25/25; B60R 25/10; B60R 25/305; B60R 25/32

(57) ABSTRACT

An authentication unit authenticates an occupant of a vehicle by face authentication. A determination unit changes a criterion for determination of success and failure in the face authentication according to a traveling state of the vehicle.

### TECHNICAL FIELD

The present disclosure relates to an occupant authentication apparatus, an occupant authentication method, and a computer-readable medium.

### BACKGROUND ART

As a related art, Patent Literature 1 discloses an authentication apparatus for a vehicle using biometric authentication. The authentication apparatus estimates the degree of risk of unauthorized use according to a situation in which the vehicle is placed. The degree of risk of unauthorized use indicates the degree of possibility that the vehicle is used without permission. In Patent Literature 1, the degree of risk of unauthorized use is estimated using factors that affect the ease of unauthorized use, such as a time zone and an area. The authentication apparatus changes an authentication level according to the estimated degree of risk of unauthorized use.

### CITATION LIST

### Patent Literature

Patent Literature 1: Japanese Unexamined Patent Application Publication No. 2007-145200

### SUMMARY OF INVENTION

### Technical Problem

However, Patent Literature 1 does not consider a case where face authentication is performed in a situation where a light environment can change. For example, in a case where an image is acquired in an environment with low light, backlighting, or overexposure, a matching degree or a verification score in the face authentication can greatly decrease even for the same person, which may result in a failure in authentication.

In view of the above circumstances, an object of the present disclosure is to provide an occupant authentication apparatus, an occupant authentication method, and a computer-readable medium capable of suppressing a failure in face authentication in a situation where a light environment may change in a case where an occupant of a vehicle is authenticated by face authentication.

### Solution to Problem

In order to achieve the above object, the present disclosure provides an occupant authentication apparatus. The occupant authentication apparatus includes: an authentication unit configured to authenticate an occupant of a vehicle by face authentication; and a determination unit configured to change a criterion for determination of success and failure in the face authentication according to a traveling state of the vehicle.

The present disclosure also provides an occupant authentication method. The occupant authentication method includes: authenticating an occupant of a vehicle by face authentication; and changing a criterion for determination of success and failure in the face authentication according to a traveling state of the vehicle.

The present disclosure provides a program. The program causes a processor to execute processing of: authenticating an occupant of a vehicle by face authentication; and changing a criterion for determination of success and failure in the face authentication according to a traveling state of the vehicle.

### Advantageous Effects of Invention

The occupant authentication apparatus, the occupant authentication method, and the computer-readable medium according to the present disclosure can suppress a failure in face authentication in a situation where a light environment may change in a case where an occupant of a vehicle is authenticated by face authentication.

### BRIEF DESCRIPTION OF DRAWINGS

FIG. 1 is a block diagram illustrating a schematic configuration of an occupant authentication apparatus according to the present disclosure.

FIG. 2 is a block diagram illustrating an occupant authentication apparatus according to a first example embodiment of the present disclosure.

FIG. 3 is a schematic diagram schematically illustrating face authentication in a certain phase.

FIG. 4 is a flowchart illustrating an operation procedure in the occupant authentication apparatus.

FIG. 5 is a block diagram illustrating a system including an occupant authentication apparatus according to a second example embodiment of the present disclosure.

FIG. 6 is a block diagram illustrating a hardware configuration of the occupant authentication apparatus.

### EXAMPLE EMBODIMENT

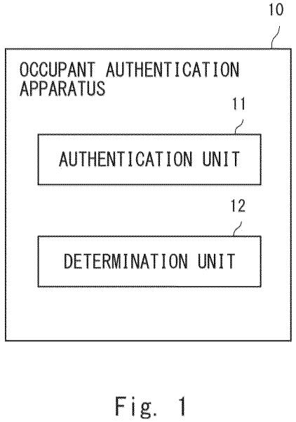

Before describing example embodiments of the present disclosure, an overview of the present disclosure will be described. FIG. 1 illustrates a schematic configuration of an occupant authentication apparatus according to the present disclosure. An occupant authentication apparatus 10 includes an authentication unit 11 and a determination unit 12. The authentication unit 11 authenticates an occupant of a vehicle by face authentication. The determination unit 12 changes a criterion for determination of success and failure in the face authentication according to a traveling state of the vehicle.

The occupant authentication apparatus 10 according to the present disclosure changes the criterion for determination of success and failure in authentication according to the traveling state of the vehicle at the time of performing the face authentication. When the vehicle is traveling, for example, a light environment around the occupant changes, and thus, there is a possibility that an image suitable for the face authentication cannot be acquired at the time of performing the face authentication. When it is assumed that the same criterion for determination is used between a state where the vehicle is traveling and a state where the vehicle is stopped, there is a possibility that the face authentication for the same person succeeds in a state where the vehicle is stopped, but the face authentication fails in a state where the vehicle is traveling. In the present disclosure, the criterion for determination changes according to the traveling state, the criterion for determination can be appropriately changed according to a change in surrounding light environment. Therefore, the occupant authentication apparatus can suppress failure in face authentication in a situation where the light environment may change.

Hereinafter, example embodiments according to the present disclosure will be described in detail with reference to the drawings. Note that in the description and drawings to be described below, omission and simplification are made as appropriate, for clarity of description. In addition, in each of the drawings described below, the same elements and similar elements are denoted by the same reference signs, and a duplicate description is omitted as necessary.

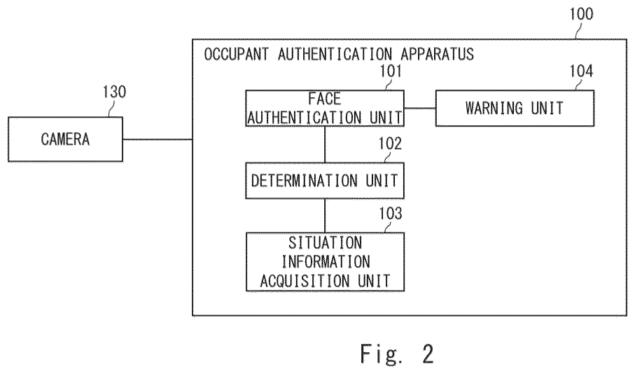

FIG. 2 illustrates an occupant authentication apparatus according to a first example embodiment of the present disclosure. An occupant authentication apparatus 100 includes a face authentication unit 101, a determination unit 102, a situation information acquisition unit 103, and a warning unit 104. The occupant authentication apparatus 100 is configured as, for example, an apparatus including one or more processors and one or more memories. At least some of the functions of the respective units in the occupant authentication apparatus 100 can be implemented by the processor executing processing according to a program read from the memory. The occupant authentication apparatus 100 corresponds to the occupant authentication apparatus 10 illustrated in FIG. 1.

In the present example embodiment, the occupant authentication apparatus 100 is used to determine whether or not an occupant of a vehicle such as an automobile, a van, or a truck is an authorized user registered in advance. The occupant authentication apparatus 100 is mounted in a vehicle, for example. For example, the occupant authentication apparatus 100 repeatedly authenticates the occupant by face authentication from when the occupant gets on the vehicle to when the occupant gets off the vehicle. The occupant authentication apparatus 100 may be used for a vehicle interior entry in a vehicle such as an automobile, in addition to the above determination. The occupant authentication apparatus 100 is not limited to the vehicle interior entry, and can be applied to authentication in various systems.

The occupant authentication apparatus 100 acquires an image of a subject, that is, the occupant, from a camera 130, and performs the face authentication using the acquired image. The camera 130 captures an image of the occupant of the vehicle as an authentication target. In the present example embodiment, the camera 130 captures an image of the inside of the vehicle. The camera 130 is installed, for example, at a position between a driver's seat and a passenger's seat where the entire inside of the vehicle can be viewed. A plurality of cameras 130 may be disposed inside the vehicle. In this case, the occupant authentication apparatus 100 may acquire images of a plurality of occupants from the plurality of cameras 130.

The face authentication unit 101 acquires the image captured by the camera 130, that is, image data of the inside of the vehicle. The face authentication unit 101 sequentially acquires the latest image data captured by the camera 130. The face authentication unit 101 detects a face region from the acquired image data. The face authentication unit 101 cuts out an image of the face region from the acquired image data. The face authentication unit 101 cuts out, for example, a face image of a driver of the vehicle from the image data. The face authentication unit 101 performs face authentication of the authentication target, that is, the occupant of the vehicle, by using the cut-out face image. The face authentication unit 101 performs the face authentication, for example, when a specific condition is satisfied. For example, the face authentication unit 101 performs the face authentication each time a predetermined time elapses from the previous face authentication.

In the face authentication unit 101, face images of one or more users who are authentication targets, that is, one or more registrants, are registered. In the following description, the face image of the registrant is also referred to as a registered image. In the face authentication unit 101, for example, a registered image of a person who holds a driver's license and can drive a vehicle is registered. In addition to or instead of the registered image, a feature amount extracted from the registered image may be registered in the face authentication unit 101.

The face authentication unit 101 verifies the face image of the occupant with the registered image. For example, the face authentication unit 101 extracts a feature amount of a face from the face image of the occupant, and compares the extracted feature amount with the feature amount extracted from the registered image. The face authentication unit 101 calculates a verification score indicating a matching degree or a similarity degree between the face image of the occupant and the registered image. In the following description, it is assumed that the higher the matching degree or the similarity degree, the higher the verification score.

The face authentication unit 101 determines whether or not the face authentication has succeeded based on the verification score. The face authentication unit 101 compares the verification score with an authentication threshold. The authentication threshold corresponds to a criterion for determination of success and failure in face authentication. The face authentication unit 101 determines whether or not the face authentication has succeeded based on a result of comparison between the verification score and the authentication threshold. For example, in a case where the verification score is equal to or higher than the authentication threshold, the face authentication unit 101 determines that the face authentication has succeeded. In a case where the verification score is lower than the authentication threshold, the face authentication unit 101 determines that the face authentication has failed. The face authentication unit 101 corresponds to the authentication unit 11 illustrated in FIG. 1.

The situation information acquisition unit 103 acquires information regarding a traveling state of the vehicle. Examples of the information regarding the traveling state of the vehicle may include a speed of the vehicle, a position of the vehicle, and a shift position. For example, the situation information acquisition unit 103 may acquire the information regarding the traveling state of the vehicle from a device such as a vehicle control electronic control unit (ECU) that controls the vehicle through an in-vehicle communication network such as a controller area network (CAN). In addition, the situation information acquisition unit 103 may acquire, as the information regarding the traveling state of the vehicle, position information of the vehicle measured using a global navigation satellite system (GNSS).

The situation information acquisition unit 103 may acquire surrounding environment information in addition to the above information. Examples of the surrounding environment information include information regarding the light environment that affects the face image captured using the camera 130. The surrounding environment information includes at least one of the presence or absence of overexposure, the presence or absence of backlighting, or an insufficient brightness of the face image. The surrounding environment information can be acquired, for example, by analyzing a luminance of each pixel of the image of the inside of the vehicle captured using the camera 130 and a histogram.

The determination unit 102 changes the authentication threshold in the face authentication unit 101 according to the information acquired by the situation information acquisition unit 103. For example, the determination unit 102 changes the authentication threshold according to whether the vehicle is traveling or stopped. For example, when the vehicle is traveling, the determination unit 102 lowers the authentication threshold as compared with a case where the vehicle is stopped. The face authentication unit 101 determines success and failure in the face authentication by using the authentication threshold determined or set by the determination unit 102. The determination unit 102 corresponds to the determination unit 12 illustrated in FIG. 1.

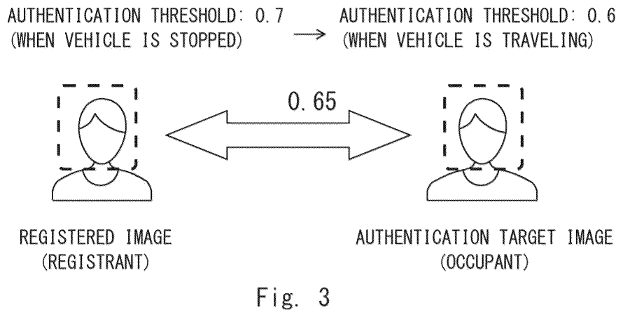

FIG. 3 schematically illustrates the face authentication in a certain phase. When the vehicle is stopped, the determination unit 102 sets the authentication threshold to a high value, for example, 0.7. On the other hand, when the vehicle is traveling, the determination unit 102 sets the authentication threshold to a low value, for example, 0.6. It is assumed that the verification score calculated by the face authentication unit 101 is 0.65. In this case, when the authentication threshold is 0.7, the face authentication unit 101 determines that the authentication has failed. On the other hand, when the authentication threshold is 0.6, the face authentication unit 101 determines that the authentication has succeeded.

When the vehicle is traveling, the light environment may change in a short time as the vehicle moves. When the vehicle is traveling, the determination unit 102 sets the authentication threshold to a low value. In this case, the face authentication unit 101 determines that the face authentication has succeeded even when the verification score, that is, the similarity degree between the registered image and the face image of the occupant is slightly low. Therefore, a possibility that the face authentication fails during traveling is reduced. On the other hand, when the vehicle is stopped, the determination unit 102 sets the authentication threshold to a high value. In this case, when the verification score is not high to some extent, the face authentication unit 101 determines that the face authentication has failed. Therefore, the face authentication unit 101 can perform the face authentication under a stricter condition while the vehicle is stopped, and can check switching of the driver when the vehicle is stopped under a strict condition.

When the vehicle is stopped, the determination unit 102 may change the authentication threshold according to whether or not the vehicle is parked or whether or not the vehicle is temporarily stopped. Examples of a state where the vehicle is temporarily stopped include a case where the vehicle is stopped at a traffic light or a case where the vehicle is stopped on a congested road. For example, the determination unit 102 may determine that the vehicle is parked in a case where the speed is 0 and the shift position is parking (P), and may determine that the vehicle is temporarily stopped in a case where the speed is 0 and the shift position is other than P. Alternatively, the determination unit 102 may determine whether the vehicle is parked or temporarily stopped based on an elapsed time from the stop of the vehicle. For example, in a case where a state in which the speed is 0 continues for a predetermined time or more after the speed becomes 0, the determination unit 102 may determine that the vehicle is parked.

The determination unit 102 may determine whether the vehicle is parked or temporarily stopped based on an image of a camera that captures an image of a region outside the vehicle. For example, the determination unit 102 may determine that the vehicle is parked when the vehicle is stopped near an edge of a road. Alternatively, the determination unit 102 may determine that the vehicle is parked when the vehicle is stopped in a parking space such as a parking lot. The determination unit 102 may verify the position information of the vehicle with map information to determine whether or not the vehicle is positioned in a parking lot. In a case where the vehicle is positioned in a parking lot, the determination unit 102 may determine that the vehicle is parked.

The determination unit 102 may change the authentication threshold based on the surrounding environment information in addition to the information regarding the traveling state. For example, the determination unit 102 may temporarily lower the authentication threshold in a case where overexposure occurs in the image, in a case where there is backlighting, or in a case where the brightness of the face image is insufficient. In this case, it is possible to reduce a possibility that the face authentication fails due to the fact that an image suitable for the face authentication is not acquired.

The warning unit 104 generates an alert in a case where the face authentication unit 101 has failed in the face authentication. The warning unit 104 may notify the occupant of the vehicle that the face authentication has failed, that is, the warning unit 104 may notify that the occupant is not a person registered in advance, by using, for example, at least one of sound or light. The warning unit 104 may generate an alert in a case where the face authentication has failed continuously for a predetermined number of times in the face authentication unit 101. Furthermore, for example, in a case where the operation of the vehicle is managed in a corporation, the warning unit 104 may notify a vehicle operation manager of the corporation of the alert. In this case, the warning unit 104 may notify that the occupant is not a person registered in advance by using, for example, a communication tool such as an electronic mail.

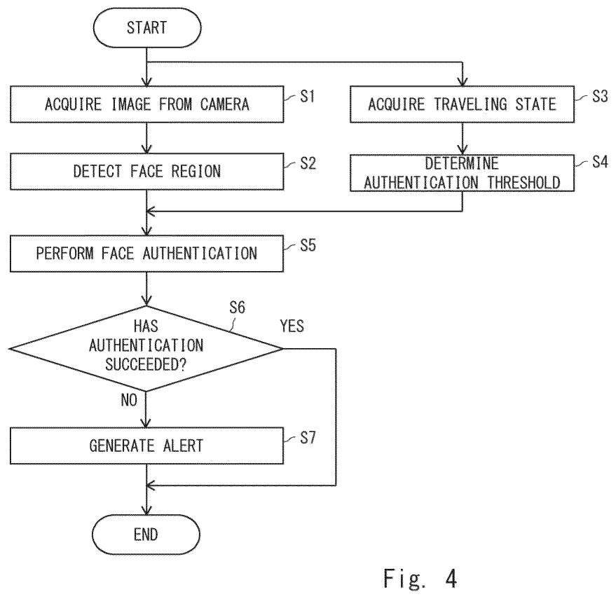

Next, an operation procedure will be described. FIG. 4 illustrates an operation procedure in the occupant authentication apparatus 100. The operation procedure in the occupant authentication apparatus 100 corresponds to an occupant authentication method. The face authentication unit 101 acquires the image of the inside of the vehicle from the camera 130 (step S1). The face authentication unit 101 detects the face region of the occupant from the image acquired from the camera 130 (step S2).

The situation information acquisition unit 103 acquires the information regarding the traveling state of the vehicle (step S3). In step S3, the situation information acquisition unit 103 may acquire the surrounding environment information of the vehicle in addition to the information regarding the traveling state of the vehicle. The determination unit 102 determines the authentication threshold according to the information acquired in step S3 (step S4). The determination unit 102 sets the authentication threshold determined in step S4 in the face authentication unit 101. Either Steps S1 and S2 or steps S3 and S4 may be performed first, or Steps S1 and S2 and steps S3 and S4 may be performed in parallel.

The face authentication unit 101 performs the face authentication on the image of the face region of the occupant detected in step S2, that is, the face image (step S5). In the face authentication, the face authentication unit 101 compares the authentication threshold determined in step S4 with the verification score. In a case where the verification score is equal to or higher than the authentication threshold, the face authentication unit 101 determines that the face authentication has succeeded. In a case where the verification score is lower than the authentication threshold, the face authentication unit 101 determines that the face authentication has failed.

The warning unit 104 determines whether or not the face authentication has succeeded in the face authentication unit 101 (step S6). In a case where the face authentication has failed in the face authentication unit 101, the warning unit 104 generates the alert (step S7). In step S7, the warning unit 104 warns the driver that a person other than the registrant is driving the vehicle inside the vehicle by using, for example, sound and light.

In the present example embodiment, the determination unit 102 changes the authentication threshold in the face authentication unit 101 according to the traveling state of the vehicle. By appropriately setting the authentication threshold according to the traveling state of the vehicle at the time of performing the face authentication, even when an image suitable for the face authentication cannot be acquired, it is possible to suppress failure in the face authentication due to the fact.

For example, when the vehicle is traveling, there is a possibility that an image suitable for the authentication cannot be acquired due to a change in light environment, and thus the determination unit 102 sets the authentication threshold to a low value. In a case where the face authentication unit 101 performs the face authentication using a low authentication threshold, it is possible to reduce a possibility that the face authentication fails due to a change in light environment during traveling of the vehicle. The occupant of the vehicle is prevented from being frequently notified of the failure of the face authentication, so that the occupant can get on the vehicle without feeling troublesome. On the other hand, in a situation where the light environment does not change, such as a state where the vehicle is stopped, the determination unit 102 sets the authentication threshold to a higher value. In this case, the face authentication unit 101 can perform the face authentication under a stricter condition, and can check the switching of the driver when the vehicle is stopped under a strict condition.

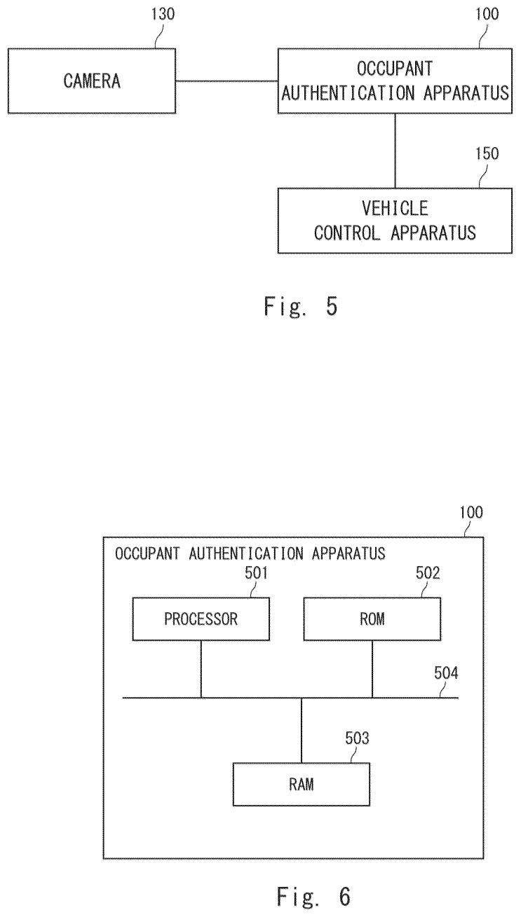

Next, a second example embodiment of the present disclosure will be described. FIG. 5 illustrates a system including an occupant authentication apparatus according to the second example embodiment of the present disclosure. In the present example embodiment, a configuration of an occupant authentication apparatus 100 may be similar to the configuration of the occupant authentication apparatus 100 described in the first example embodiment illustrated in FIG. 2. In the present example embodiment, in a case where a face authentication unit 101 fails in face authentication, the occupant authentication apparatus 100 notifies a vehicle control apparatus 150 that the face authentication has failed. In a case where the face authentication unit 101 fails in the face authentication continuously for a predetermined number of times, the occupant authentication apparatus 100 may notify the vehicle control apparatus 150 that the face authentication has failed. In the present example embodiment, the occupant authentication apparatus 100 does not have to include a warning unit 104.

The vehicle control apparatus 150 includes a vehicle control ECU that performs vehicle traveling control or the like. In general, the vehicle control ECU includes a processor, a memory, an input/output (I/O), and a bus that connects them. The vehicle control ECU acquires sensor information from a vehicle sensor, and performs the vehicle traveling control or the like. The vehicle sensor is a sensor that detects various states of a mobile body. Examples of the vehicle sensor include sensors such as a vehicle speed sensor that detects a vehicle speed, a steering sensor that detects a steering angle, an accelerator opening sensor that detects the degree of opening of an accelerator pedal, and a brake pedal force sensor that detects a depression amount of a brake pedal, and the like. The vehicle control ECU performs, based on the sensor information output by the vehicle sensor, various types of controls, such as control of a fuel injection amount, an engine ignition timing, and an assist amount of power steering.

The vehicle control apparatus 150 may include an automated driving ECU that controls automated driving of the vehicle. The automated driving ECU includes a processor, a memory, an I/O, and a bus that connects them. The automated driving ECU acquires sensor information from a surrounding monitoring sensor and a vehicle sensor, and controls automated traveling of the vehicle based on the acquired sensor information. The surrounding monitoring sensor is a sensor that monitors surrounding situations of the mobile body. The surrounding monitoring sensor includes, for example, a camera, a radar, and a light detection and ranging (LiDAR). The surrounding monitoring sensor may include, for example, a plurality of cameras to capture images of the front, rear, right, and left sides of the vehicle.

For example, in a case where a notification indicating that the face authentication has failed is received from the occupant authentication apparatus 100, the vehicle control apparatus 150 stops the vehicle on a road shoulder. For example, the vehicle control apparatus 150 instructs the automated driving ECU to stop the vehicle, and the automated driving ECU automatically stops the vehicle on the road shoulder. In a case where the vehicle is traveling by the automated driving, the vehicle control apparatus 150 may terminate the automated driving and switch a driving mode of the vehicle from the automated driving to manual driving. The vehicle control apparatus 150 may switch the driving mode of the vehicle to the automated driving and cause the vehicle to travel by the automated driving in a case where a notification indicating that the face authentication has succeeded is received from the occupant authentication apparatus 100 after stopping the vehicle on the road shoulder or after switching to the manual driving.

In the present example embodiment, in a case where the face authentication has failed in the occupant authentication apparatus 100, the vehicle control apparatus 150 stops the vehicle on the road shoulder. Alternatively, in a case where the vehicle is traveling by the automated driving, the vehicle control apparatus 150 terminates the automated driving. In this way, it is possible to suppress unauthorized use of the vehicle by a person other than a registered person, that is, an authorized user. Other effects are similar to those in the first example embodiment.

In the above example embodiments, an example in which the occupant authentication apparatus 100 is mounted in a vehicle has been described. However, the present disclosure is not limited thereto. In the present disclosure, the occupant authentication apparatus 100 is not necessarily mounted in a vehicle. The occupant authentication apparatus 100 may be an apparatus installed outside the vehicle. In this case, the occupant authentication apparatus 100 may acquire an image captured by the camera 130 via a wireless communication network.

In the present disclosure, the occupant authentication apparatus 100 is not necessarily a single apparatus. The occupant authentication apparatus 100 may be configured using a plurality of physically separated apparatuses. In addition, the occupant authentication apparatus 100 does not necessarily have all the functions mounted in the vehicle or disposed outside the vehicle. For example, some of the functions of the occupant authentication apparatus 100 may be disposed outside the vehicle, and the remaining functions may be mounted in the vehicle.

Next, a hardware configuration of the occupant authentication apparatus 100 will be described. FIG. 6 illustrates the hardware configuration of the occupant authentication apparatus 100. The occupant authentication apparatus 100 includes a processor (central processing unit (CPU)) 501, a read only memory (ROM) 502, and a random access memory (RAM) 503. In the occupant authentication apparatus 100, the processor 501, the ROM 502, and the RAM 503 are interconnected via a bus 504. Although not illustrated, the occupant authentication apparatus 100 may include other circuits such as a peripheral circuit, a communication circuit, and an interface circuit.

The ROM 502 is a non-volatile storage device. For example, a semiconductor storage device such as a flash memory having a relatively small capacity is used for the ROM 502. The ROM 502 stores a program executed by the processor 501.

The program described above includes a group of commands (or software codes) for causing a computer to perform one or more functions described in the example embodiments when the program is read by the computer. The program may be stored in a non-transitory computer-readable medium or a tangible storage medium. As an example and not by way of limitation, a computer-readable medium or tangible storage medium includes a RAM, a ROM, a flash memory, a solid-state drive (SSD) or other memory technology, a compact disc (CD), a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

The RAM 503 is a volatile storage device. As the RAM 503, various types of semiconductor memory devices such as a dynamic random access memory (DRAM) or a static random access memory (SRAM) can be used. The RAM 503 can be used as an internal buffer for transitory storing data and the like.

The processor 501 loads the program stored in the ROM 502 on the RAM 503, and executes the program. The functions of the respective units in the occupant authentication apparatus 100 can be implemented by the CPU 501 executing the program.

Although the example embodiments according to the present disclosure have been described above in detail, the present disclosure is not limited to the above-described example embodiments, and the present disclosure also includes those that are obtained by making changes or modifications to the above-described example embodiments without departing from the gist of the present disclosure.

For example, some or all of the example embodiments disclosed above can be described as, but not limited to, the following Supplementary Notes.

### [Supplementary Note 1]

An occupant authentication apparatus including:
an authentication unit configured to authenticate an occupant of a vehicle by face authentication; and
a determination unit configured to change a criterion for determination of success and failure in the face authentication according to a traveling state of the vehicle.

### [Supplementary Note 2]

The occupant authentication apparatus according to Supplementary Note 1, in which the determination unit changes the criterion for determination according to whether the vehicle is traveling or stopped.

### [Supplementary Note 3]

The occupant authentication apparatus according to Supplementary Note 1 or 2, in which the determination unit lowers the criterion for determination when the vehicle is traveling as compared to when the vehicle is stopped.

### [Supplementary Note 4]

The occupant authentication apparatus according to any one of Supplementary Notes 1 to 3, in which the determination unit changes the criterion for determination further according to surrounding environment information of the vehicle.

### [Supplementary Note 5]

The occupant authentication apparatus according to any one of Supplementary Notes 1 to 4, in which the authentication unit repeatedly performs the face authentication from when the occupant gets in the vehicle to when the occupant gets off the vehicle.

### [Supplementary Note 6]

The occupant authentication apparatus according to any one of Supplementary Notes 1 to 5, in which the determination unit changes the criterion for determination according to whether the vehicle is parked or temporarily stopped when the vehicle is stopped.

### [Supplementary Note 7]

The occupant authentication apparatus according to any one of Supplementary Notes 1 to 6, further including a warning unit configured to generate an alert in a case where the face authentication has failed in the authentication unit.

### [Supplementary Note 8]

The occupant authentication apparatus according to any one of Supplementary Notes 1 to 7, in which the authentication unit verifies a face image of the occupant or a feature amount extracted from the face image with a registered image of a registrant or a feature amount extracted from the registered image, calculates a verification score indicating a matching degree between the occupant and the registrant, compares the calculated verification score with the criterion for determination, and determines whether or not the face authentication has succeeded based on a result of the comparison.

### [Supplementary Note 9]

The occupant authentication apparatus according to Supplementary Note 8, in which
the determination unit determines a threshold for the verification score as the criterion for determination, and
the authentication unit determines whether or not the face authentication has succeeded according to whether or not the verification score is equal to or higher than the threshold.

### [Supplementary Note 10]

An occupant authentication method including:
authenticating an occupant of a vehicle by face authentication; and
changing a criterion for determination of success and failure in the face authentication according to a traveling state of the vehicle.

### [Supplementary Note 11]

A program for causing a processor to execute processing of:
authenticating an occupant of a vehicle by face authentication; and
changing a criterion for determination of success and failure in the face authentication according to a traveling state of the vehicle.

This application claims priority based on Japanese Patent Application No. 2022-138697 filed Aug. 31, 2022, the entire disclosure of which is incorporated herein.

### REFERENCE SIGNS LIST

10 OCCUPANT AUTHENTICATION APPARATUS
11 AUTHENTICATION UNIT
12 DETERMINATION UNIT
100 OCCUPANT AUTHENTICATION APPARATUS
101 FACE AUTHENTICATION UNIT
102 DETERMINATION UNIT
103 SITUATION INFORMATION ACQUISITION UNIT
104 WARNING UNIT
130 CAMERA
150 VEHICLE CONTROL APPARATUS

What is claimed is:

1. An occupant authentication apparatus comprising:
at least one memory storing instructions; and
at least one processor configured to execute the instructions to:
authenticate an occupant of a vehicle by face authentication; and
change a criterion for determination of success and failure in the face authentication according to a traveling state of the vehicle.

2. The occupant authentication apparatus according to claim 1, wherein the at least one processor is configured to execute the instructions to change the criterion for determination according to whether the vehicle is traveling or stopped.

3. The occupant authentication apparatus according to claim 1, wherein the at least one processor is configured to execute the instructions to lower the criterion for determination when the vehicle is traveling as compared to when the vehicle is stopped.

4. The occupant authentication apparatus according to claim 1, wherein the at least one processor is configured to execute the instructions to change the criterion for determination further according to surrounding environment information of the vehicle.

5. The occupant authentication apparatus according to claim 1, wherein the at least one processor is configured to execute the instructions to the repeatedly perform the face authentication from when the occupant gets in the vehicle to when the occupant gets off the vehicle.

6. The occupant authentication apparatus according to claim 1, wherein the at least one processor is configured to execute the instructions to change the criterion for determination according to whether the vehicle is parked or temporarily stopped when the vehicle is stopped.

7. The occupant authentication apparatus according to claim 1, the at least one processor is further configured to execute the instructions to generate an alert in a case where the face authentication has failed in the authentication unit.

8. The occupant authentication apparatus according to claim 1, wherein the at least one processor is configured to execute the instructions to verify a face image of the occupant or a feature amount extracted from the face image with a registered image of a registrant or a feature amount extracted from the registered image, calculate a verification score indicating a matching degree between the occupant and the registrant, compare the calculated verification score with the criterion for determination, and determine whether or not the face authentication has succeeded based on a result of the comparison.

9. The occupant authentication apparatus according to claim 8, wherein the at least one processor is configured to execute the instructions to:
determine a threshold for the verification score as the criterion for determination, and
determine whether or not the face authentication has succeeded according to whether or not the verification score is equal to or higher than the threshold.

10. An occupant authentication method comprising:
authenticating an occupant of a vehicle by face authentication; and
changing a criterion for determination of success and failure in the face authentication according to a traveling state of the vehicle.

11. A non-transitory computer-readable medium storing a program for causing a processor to execute processing of:
authenticating an occupant of a vehicle by face authentication; and
changing a criterion for determination of success and failure in the face authentication according to a traveling state of the vehicle.
